(19) United States
(12) Patent Application Publication
(10) Pub. No.: US 2022/0337448 A1
(43) Pub. Date: Oct. 20, 2022

(54) CONNECTED HOUSEHOLD APPLIANCES WITH DISTRIBUTED CYCLE PARAMETERS

(71) Applicant: Haier US Appliance Solutions, Inc., Wilmington, DE (US)

(72) Inventor: Kyle Edward Durham, Louisville, KY (US)

(21) Appl. No.: 17/234,830

(22) Filed: Apr. 20, 2021

(51) Int. Cl. H04L 12/28

(52) U.S. Cl. CPC H04L 12/2832; H04L 12/2827; H04L 12/2816; H04L 2012/285

(57) ABSTRACT

A method of operating a plurality of household appliances connected to a data server includes applying a test value to one or more cycle parameters of the plurality of household appliances and performing a cycle according to the test value of the one or more cycle parameters with one or more household appliances of the plurality of household appliances. The method also includes collecting performance data related to the one or more household appliances of the plurality of household appliances during or after performing the cycle according to the test value of the one or more cycle parameters. An optimized value for each of the one or more cycle parameters is developed based on the performance data, and the optimized value for each of the one or more cycle parameters is applied to the plurality of household appliances.

### FIELD

The present subject matter relates generally to household appliances, and in particular to connected household appliances with distributed operating parameters, such as distributed cycle parameters.

### BACKGROUND

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances. Such household appliances are generally configured for and capable of performing different operations or cycles according to multiple variables, such as, in a washing machine appliance, a wash volume of water, a rinse volume of water, one or more spin speeds, etc., or, in a coffee maker, a wetting volume of water, a dwell or bloom time, a water temperature, etc.

As an example of one type of such household appliances, dishwasher appliances generally include a tub that defines a wash compartment or wash chamber. Rack assemblies can be mounted within the wash chamber of the tub for receipt of articles for washing. Spray assemblies within the wash chamber can apply or direct wash fluid towards articles disposed within the rack assemblies in order to clean such articles. Multiple spray assemblies can be provided including e.g., a lower spray arm assembly mounted to the tub at a bottom of the wash chamber, a mid-level spray arm assembly mounted to one of the rack assemblies, and/or an upper spray assembly mounted to the tub at a top of the wash chamber.

Dishwasher appliances further typically include a fluid circulation system which is in fluid communication with the spray assemblies for circulating fluid to the spray assemblies. The fluid circulation system generally receives fluid from the wash chamber, filters soil from the fluid, and pumps the filtered fluid to the spray assemblies. Additionally, unfiltered fluid can be pumped to a drain as required. Dishwasher appliances also typically include one or more dry components, such as a heater and/or fan.

Various operations of the dishwasher appliance, e.g., operations of the fluid circulation system, dry components, or other components of the dishwasher appliance, can be modified by changing one or more cycle parameters. Such parameters include water volume(s) supplied to and/or drained from the dishwasher appliance during operation, wash pump circulation time(s) and/or speeds, additive release timing, water temperature, drying air temperature, drying fan speed and/or operation time, among numerous others. In light of the large number of parameters, including combinations thereof, which could be varied or adjusted in each cycle of the dishwasher appliance and the limited opportunities to test the dishwasher appliance prior to shipping, dishwasher appliances are often sold to an end user with preprogrammed settings (e.g., cycle parameters) which may not be optimal for every use case and/or which may be amenable to further optimization.

Accordingly, household appliances and related methods which provide the ability to create and/or access large data sets from across numerous units in various locations and use conditions would be desired in the art.

### BRIEF DESCRIPTION

Aspects and advantages of the technology will be set forth in part in the following description, or may be apparent from the description, or may be learned through practice of the technology.

In an exemplary embodiment, a method of operating a plurality of household appliances is provided. The plurality of household appliances are connected to a data server. The method includes applying a test value to one or more cycle parameters of one or more household appliances of the plurality of household appliances. The method further includes collecting sensor data from one or more internal sensors in each of the one or more household appliances of the plurality of household appliances to which the test value was applied while the one or more household appliances of the plurality of household appliances to which the test value was applied perform a cycle according to the test value of the one or more cycle parameters and collecting user feedback data from users of the one or more household appliances of the plurality of household appliances to which the test value was applied after the one or more household appliances of the plurality of household appliances to which the test value was applied perform the cycle according to the test value of the one or more cycle parameters. The method further includes developing an optimized value for each of the one or more cycle parameters based on the sensor data and the user feedback data and applying the optimized value for each of the one or more cycle parameters to the one or more household appliances of the plurality of household appliances to which the test value was applied.

In another exemplary embodiment, a method of operating a plurality of household appliances appliance is provided. The plurality of household appliances are connected to a data server. The method includes applying a test value to one or more cycle parameters of the plurality of household appliances. The method further includes performing a cycle according to the test value of the one or more cycle parameters with one or more household appliances of the plurality of household appliances and collecting performance data related to the one or more household appliances of the plurality of household appliances during or after the cycle according to the test value of the one or more cycle parameters. The method also includes developing an optimized value for each of the one or more cycle parameters based on the performance data and applying the optimized value for each of the one or more cycle parameters to the plurality of household appliances.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures.

FIG. 1 provides a front view of an example dishwasher appliance in accordance with at least one embodiment of the present subject matter.

FIG. 2 provides a cross-sectional side view of the dishwasher appliance shown in FIG. 1, particularly illustrating various internal components of the dishwasher appliance.

FIG. 3 provides a schematic illustration of a plurality of household appliances, which may be a plurality of dishwasher appliances such as the dishwasher appliance of FIGS. 1 and 2, where the plurality of household appliances are connected to a data server in accordance with at least one embodiment of the present subject matter.

FIG. 4 provides a flow chart diagram illustrating an exemplary method of operating a plurality of household appliances according to at least one embodiment of the present subject matter.

FIG. 5 provides a flow chart diagram illustrating another exemplary method of operating a plurality of household appliances according to at least one additional embodiment of the present subject matter.

### DETAILED DESCRIPTION

Reference now will be made in detail to embodiments of the technology, one or more examples of which are illustrated in the drawings. Each example is provided by way of explanation of the technology, not limitation of the technology. In fact, it will be apparent to those skilled in the art that various modifications and variations can be made in the present disclosure without departing from the scope or spirit of the invention. For instance, features illustrated or described as part of one embodiment can be used with another embodiment to yield a still further embodiment. Thus, it is intended that the present technology covers such modifications and variations as come within the scope of the appended claims and their equivalents.

As used herein, the terms “first,” “second,” and “third” may be used interchangeably to distinguish one component from another and are not intended to signify location or importance of the individual components. As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The present disclosure generally pertains to a plurality of household appliances, where each household appliance of the plurality of household appliances is of the same general type, e.g., a plurality of washing machine appliances, a plurality of coffee makers, a plurality of microwave oven appliances, a plurality of refrigerator appliances, etc. Further, the household appliances of the plurality of household appliances may comprise the same model or series of appliances or otherwise a group of household appliances having the same or similar functionality and available options. For example, a plurality of washing machine appliances all having the same or similar inlet valve manifold, pump system, basket motor, and/or other common features across the entire group of appliances, whereby providing the same operating parameters, e.g., a valve open time, for all of the appliances in the plurality of household appliances would be expected to produce the same result (although variations may occur in practice due to variations such as different installation conditions, different maintenance levels, etc.). As another example, which will be described in more detail below, the plurality of household appliances may be a plurality of dishwasher appliances, where the dishwasher appliances all have common features, such as the same number and type of spray assemblies, e.g., rotary spray arms, spray heads, or other spray components such as bottle washers, utensil jets, etc.

It should be understood that “household appliances” and/or “appliances” are used herein to describe appliances typically used or intended for common domestic tasks, such as laundry appliances or kitchen appliances, or air conditioners, dishwashing appliances, water heaters, etc., and any other household appliance which performs similar functions in addition to network communication and data processing. Thus, devices such as a personal computer, router, and other similar devices the primary functions of which are network communication and/or data processing are not considered household appliances as used herein.

According to various embodiments of the present disclosure, the plurality of household appliances described herein may take the form of any of the examples described, or may be any other household appliance. Thus, it will be understood that the present subject matter is not limited to any particular household appliance. In general, the household appliances of the plurality of household appliances include features for their primary functions or domestic tasks, e.g., washing dishes (in the case of a plurality of dishwasher appliances), making ice (in the case of a plurality of refrigerator appliances or ice maker appliances), or heating food items (in the case of various cooking appliances, including microwave ovens, cooktops, etc., and in particular oven appliances with multiple heating sources, e.g., combination oven appliances with, for example, microwave and convection heating, sometimes also known as speed cook appliances), and also include features for connecting and communicating wirelessly, such as over a wireless network. Such communication may provide connected features on the household appliances, e.g., where some or all household appliances of the plurality of household appliances communicate with, e.g., other appliances in the plurality of household appliances and/or a remote database such as a cloud server.

Thus, the plurality of household appliances includes a group of appliances all of which perform the same primary function(s) in the same way. As an example of a household appliance with more than one primary function, a refrigerator appliance may include features for chilled storage of food items and features for making ice, preparing and/or dispensing beverages, etc., all of which are considered “domestic tasks” as discussed herein and are therefore all considered primary functions of the refrigerator appliances, whereas the network communication features are considered non-primary or secondary functions. As noted, such household appliances are thus distinct from devices such as computers, smartphones, etc., where network communication and/or data processing are considered the primary function of such devices.

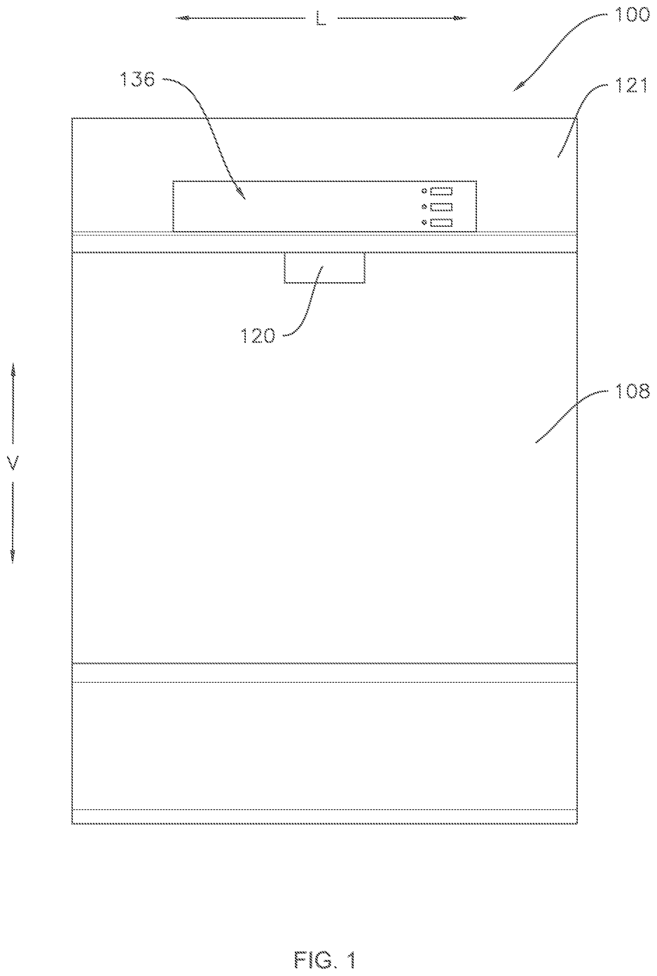

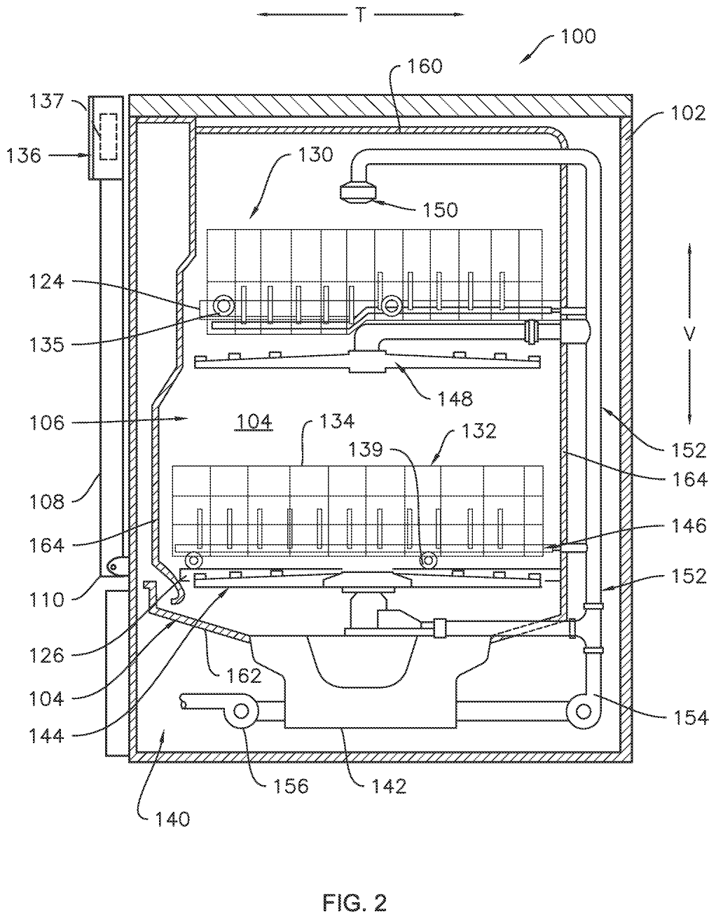

Referring now to the drawings, FIGS. 1 and 2 illustrate one embodiment of a household appliance 100, which in this example is a domestic dishwasher appliance 100, in accordance with aspects of the present disclosure. As shown in FIGS. 1 and 2, the dishwasher appliance 100 may include a cabinet 102 having a tub 104 therein defining a wash chamber 106. The tub 104 may generally include a front opening (not shown) and a door 108 hinged at its bottom 110 for movement between a normally closed vertical position (shown in FIGS. 1 and 2), wherein the wash chamber 106 is sealed shut for washing operation, and a horizontal open position (not shown) for loading and unloading of articles from the dishwasher appliance 100. The door 108 may include a handle 120, such as a pocket handle, formed therein that, for example, a user may grasp in order to push and/or pull the door 108 when opening and closing door 108.

As is understood, the tub 104 may generally have a rectangular cross-section defined by various wall panels or walls. For example, as shown in FIG. 2, the tub 104 may include a top wall 160 and a bottom wall 162 spaced apart from one another along a vertical direction V of the dishwasher appliance 100. Additionally, the tub 104 may include a plurality of sidewalls 164 (e.g., four sidewalls) extending between the top and bottom walls 160, 162. It should be appreciated that the tub 104 may generally be formed from any suitable material. However, in several embodiments, the tub 104 may be formed from a ferritic material, such as stainless steel, or a polymeric material.

As particularly shown in FIG. 2, upper and lower guide rails 124, 126 may be mounted on opposing side walls 164 of the tub 104 and may be configured to accommodate roller-equipped rack assemblies 130 and 132. Each of the rack assemblies 130, 132 may be fabricated into lattice structures including a plurality of elongated members 134 (for clarity of illustration, not all elongated members making up assemblies 130 and 132 are shown in FIG. 2). Additionally, each rack 130, 132 may be adapted for movement along a transverse direction T between an extended loading position (not shown) in which the rack is substantially positioned outside the wash chamber 106, and a retracted position (shown in FIGS. 1 and 2) in which the rack is located inside the wash chamber 106. This may be facilitated by rollers 135 and 139, for example, mounted onto racks 130 and 132, respectively. As is generally understood, a silverware basket (not shown) may be removably attached to rack assembly 132 for placement of silverware, utensils, and the like, that are otherwise too small to be accommodated by the racks 130, 132. As may be seen collectively in FIGS. 1 and 2, the dishwasher appliance 100 may define the vertical direction V, the transverse direction T, and a lateral direction L. The vertical direction V, lateral direction L, and transverse direction T are mutually perpendicular and form an orthogonal direction system.

Additionally, the dishwasher appliance 100 may also include a lower spray-arm assembly 144 that is configured to be rotatably mounted within a lower region 146 of the wash chamber 106 directly above the bottom wall 162 of the tub 104 so as to rotate in relatively close proximity to the rack assembly 132. As shown in FIG. 2, a mid-level spray-arm assembly 148 may be located in an upper region of the wash chamber 106, such as by being located in close proximity to the upper rack 130. Moreover, an upper spray assembly 150 may be located above the upper rack 130.

As is generally understood, the lower and mid-level spray-arm assemblies 144, 148 and the upper spray assembly 150 may generally form part of a fluid circulation system 152 for circulating fluid (e.g., water and dishwasher fluid which may also include water, detergent, and/or other additives, and may be referred to as wash liquor) within the tub 104. As shown in FIG. 2, the fluid circulation system 152 may also include a recirculation pump 154 located in a machinery compartment 140 below the bottom wall 162 of the tub 104, as is generally recognized in the art, and one or more fluid conduits for circulating the fluid delivered from the pump 154 to and/or throughout the wash chamber 106. The tub 104 may include a sump 142 positioned at a bottom of the wash chamber 106 for receiving fluid from the wash chamber 106. The recirculation pump 154 receives fluid from sump 142 to provide a flow to fluid circulation system 152, which may include a switching valve or diverter (not shown) to select flow to one or more of the lower and mid-level spray-arm assemblies 144, 148 and the upper spray assembly 150.

Moreover, each spray-arm assembly 144, 148 may include an arrangement of discharge ports or orifices for directing washing liquid onto dishes or other articles located in rack assemblies 130 and 132, which may provide a rotational force by virtue of washing fluid flowing through the discharge ports. The resultant rotation of the spray-arm assembly 144 and/or 148 provides coverage of dishes and other dishwasher contents with a washing spray.

A drain pump 156 may also be provided in the machinery compartment 140 and in fluid communication with the sump 142. The drain pump 156 may be in fluid communication with an external drain (not shown) to discharge fluid, e.g., used wash liquid, from the sump 142.

The dishwasher appliance 100 may be further equipped with a controller 137 configured to regulate operation of the dishwasher 100. The controller 137 may generally include one or more memory devices and one or more microprocessors, such as one or more general or special purpose microprocessors operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher appliance 100. In the illustrated embodiment, the controller 137 is located within a control panel area 121 of the door 108, as shown in FIG. 1. In such an embodiment, input/output (“I/O”) signals may be routed between the control system and various operational components of the dishwasher appliance 100 along wiring harnesses that may be routed through the bottom of the door 108. Typically, the controller 137 is in operative communication with a user interface panel 136 (sometimes also referred to as a control panel) through which a user may select various operational features and modes and monitor progress of the dishwasher 100. In one embodiment, the user interface panel 136 may represent a general purpose I/O (“GPIO”) device or functional block. Additionally, the user interface panel 136 may include input components, such as one or more of a variety of electrical, mechanical or electro-mechanical input devices including rotary dials, push buttons, touch pads, and/or touch screens. The user interface panel 136 may also include a display component, such as a digital or analog display device designed to provide operational feedback to a user. As is generally understood, the user interface panel 136 may be in communication with the controller 137 via one or more signal lines or shared communication busses. It should be noted that controllers 137 as disclosed herein are capable of and may be operable to perform any methods and associated method steps as disclosed herein.

It should be appreciated that the present subject matter is not limited to any particular style, model, or configuration of dishwasher appliance. The exemplary embodiment depicted in FIGS. 1 and 2 is simply provided for illustrative purposes only. For example, different locations may be provided for the user interface panel 136, different configurations may be provided for the racks 130, 132, and other differences may be applied as well.

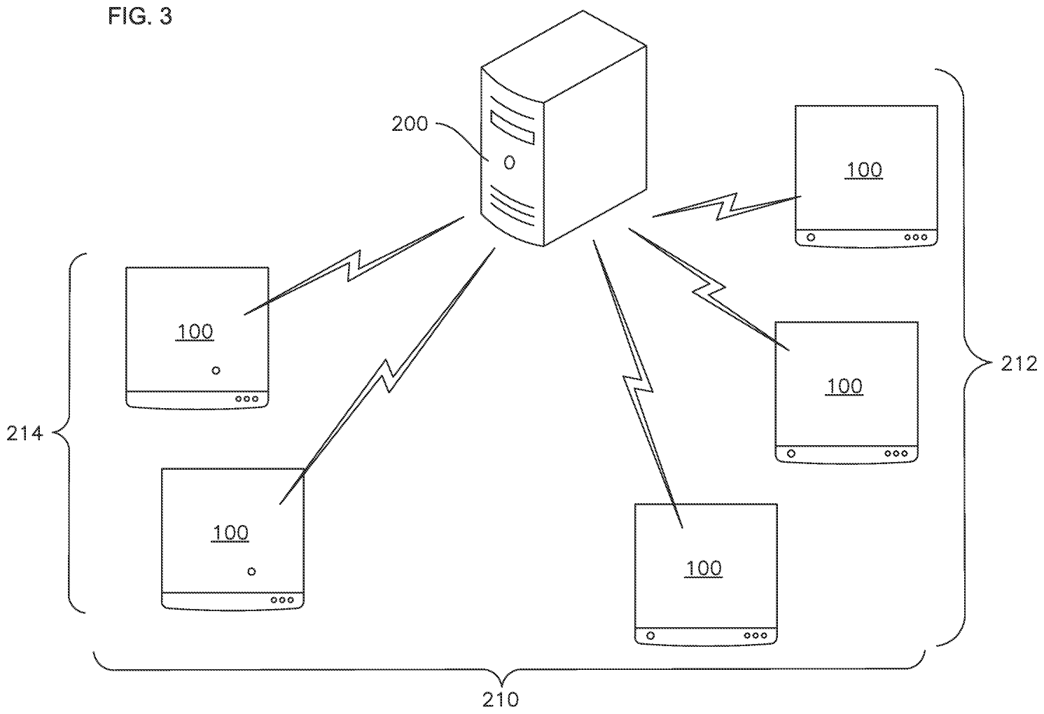

Turning now to FIG. 3, in various embodiments of the present subject matter, a plurality 210 of household appliances 100 may be connected to a data server 200. The plurality 210 of household appliances 100 may be dishwasher appliances 100 and, in such embodiments, one or more of the dishwasher appliances 100 may be the example dishwasher appliance 100 illustrated in FIGS. 1 and 2, or may include some of the same or similar features as shown in FIGS. 1 and 2 and described above. In some embodiments, all of the dishwasher appliances 100 of the plurality 210 of dishwasher appliances 100 may be the same as or similar to the example dishwasher appliance 100. It also should be understood that the present subject matter may be used with any type of dishwasher appliance, and is not necessarily limited to the example dishwasher appliance 100 of FIGS. 1 and 2, e.g., in some embodiments, none of the dishwasher appliances 100 of the plurality 210 of dishwasher appliances 100 may be exactly the same as the example dishwasher appliance 100 of FIGS. 1 and 2.

Further, the plurality 210 of household appliances 100 may, in other embodiments, be a plurality of any other type of household appliance, as described above. As mentioned above, each household appliance 100 of the plurality 210 of household appliances 100 includes include features for connecting and communicating wirelessly, such as over a wireless network. Accordingly, regardless of the particular type of household appliance, each appliance of the plurality of household appliances may include a controller, such as the example controller 137 described above in the context of the dishwasher appliance example, and a wireless communication module connected to the controller or incorporated therein. As mentioned, the controller 137 may include one or more memory devices. The memory devices may also store data that can be retrieved, manipulated, created, or stored by the one or more processors or portions of controller 137. The data can include, for instance, data to facilitate performance of methods described herein. The data can be stored locally (e.g., on controller 137) in one or more databases and/or may be split up so that the data is stored in multiple locations. In addition, or alternatively, the one or more database(s) can be connected to controller 137 through any suitable network(s), such as through a high bandwidth local area network (LAN) or wide area network (WAN). In this regard, for example, controller 137 may further include a communication module or interface that may be used to communicate with one or more other component(s) of appliance 100, controller 137, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As noted in FIG. 3, the plurality 210 of household appliances 100 may include a first plurality 212 of household appliances 100 (the first plurality 212 consisting of three household appliances 100 in the example illustrated in FIG. 3) and a second plurality 214 of household appliances 100 (the second plurality 214 consisting of two household appliances 100 in the example illustrated in FIG. 3). For example, in some embodiments, exemplary methods may include, and/or exemplary household appliances may be configured for, receiving an opt-in from a user of the (each) respective household appliance 100 and performing various steps or operations based on whether or not the opt-in is received for each particular unit. Thus, for example, the first plurality 212 of household appliances 100 may be a plurality of opted-in units, e.g., units for which an opt-in has been received from a corresponding or associated user, and the second plurality 214 of household appliances 100 may be a plurality of non-opted in units, e.g., units for which an opt-in has not been received from a corresponding or associated user. As will be discussed further below, opting in may include providing a prompt to opt in on a user interface associated with each household appliance 100 of the plurality 210 of household appliances 100, and the opted-in units 212 may be those household appliances 100 for which an affirmative response to the prompt to opt in is received from the associated user interface, and the non-opted in units may be those household appliances 100 for which an affirmative response to the prompt to opt in is not received from the associated user interface. The associated user interface may be a user interface that is physically connected to and/or incorporated with the household appliance 100, such as the user interface panel 136 illustrated in FIGS. 1 and 2, or may be provided on a remote user interface device, e.g., a computer, tablet, smart phone, smart watch, smart home system, or other similar device, which is remote from the household appliance 100 (e.g., not physically connected thereto). The remote user interface device may be wirelessly connected to the household appliance 100, and may be associated with the household appliance 100 in that the remote user interface device is wirelessly coupled to and/or otherwise paired with the household appliance 100. For example, the remote user interface may be a computing device which stores and runs software, e.g., applications or “apps,” including an appliances app through which the remote user interface device is associated with the household appliance 100 in one or more remote servers, such as the data server 200.

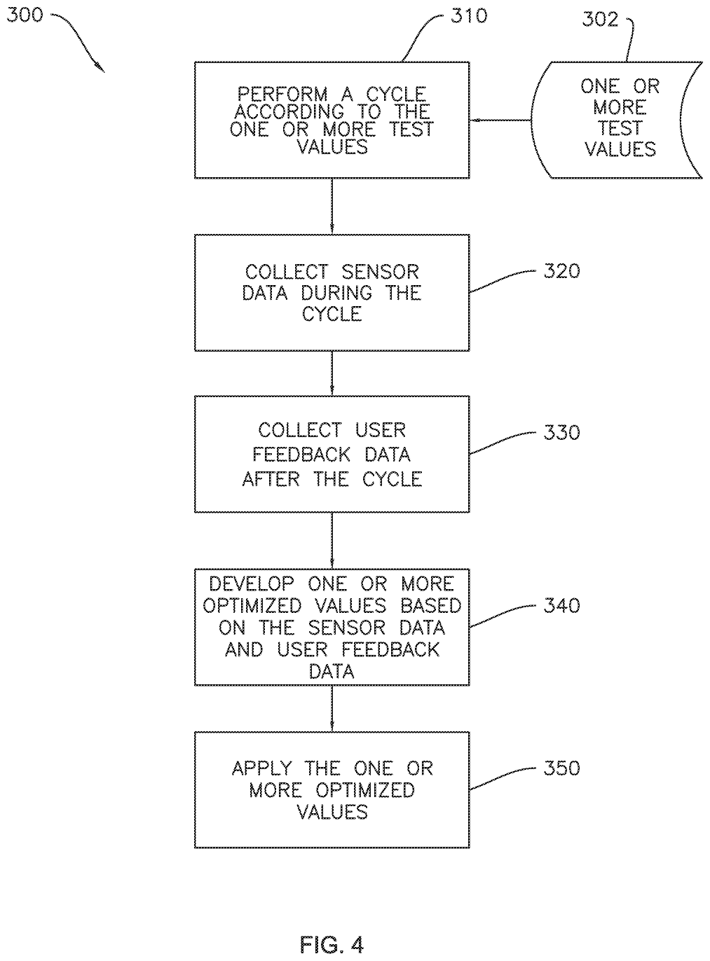

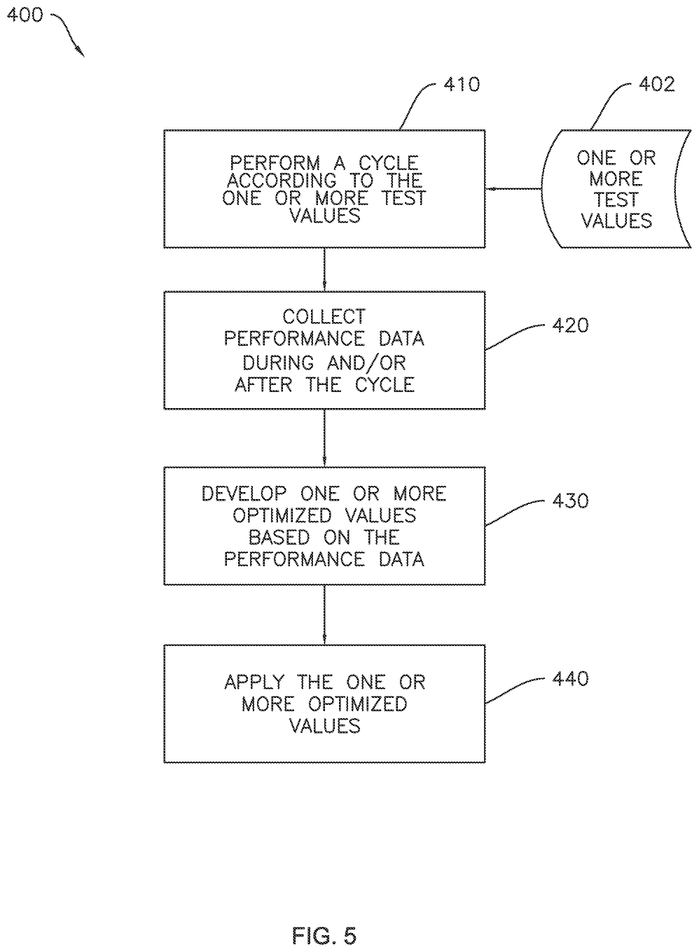

Embodiments of the present subject matter also include methods of operating a plurality of household appliances, such as the plurality 210 of household appliances 100 illustrated in FIG. 3, and/or one or both of the first 212 plurality of household appliances 100 and the second 214 plurality of household appliances 100 which are also illustrated in FIG. 3. One example of such methods is method 300 illustrated in FIG. 4 and another example of such methods is method 400 illustrated in FIG. 5. As shown in FIGS. 4 and 5, the method 300 or 400 may include receiving external data 302 or 402 (e.g., data from a source that is external the household appliances, such as from the data server 200), where the external data 302 or 402 is or includes a test value for one or more cycle parameters. Examples of the cycle parameter or parameters for which the test value is received may include, in various embodiments where the household appliance is a dishwasher appliance, any one or more of intended fill water volume(s), wash pump circulation time(s), diverter position profile(s), count of fill/circulate/drain segments, intended drain water volume(s), wash fluid heater on/off time(s), target temperature for circulation(s), detergent release point, rinse-aid release point, dry heater on/off time(s), dry fan(s) on/off time(s), circulation pump RPM, and/or drain pump RPM, among other possible examples. The received test value or values may then be applied to the corresponding cycle parameter(s), e.g., parametric values stored in the memory of the controller may be added or overwritten with the test value(s). As illustrated in FIG. 4, the method 300 may include a step 310 of performing a cycle according to the test value or values for the one or more cycle parameters, and the method 400 illustrated in FIG. 5 may also include a step 410 of performing a cycle according to the test value or values for the one or more cycle parameters. The cycle performed according to the test value or values for the one or more cycle parameters may include, for example, a wash operation and/or rinse operation wherein stages or steps of the cycle are set to the test value, such as a wash operation wherein a detergent release point (timing) is the test value (or one of the test values) received at 302 in FIG. 4 or at 402 in FIG. 5, a rinse operation wherein a circulation pump speed (RPM) is the test value (or one of the test values) received at 302 in FIG. 4 or at 402 in FIG. 5, among numerous other possible examples, including combinations of multiple test values for different cycle parameters. For example, one possible combination of multiple test values for different cycle parameters may be a wash cycle comprising a wash stage and a rinse stage, where the detergent release point during the wash stage is one test value and the circulation pump RPM during the rinse stage and/or the wash stage is another test value in the same cycle.

As illustrated at 420 in FIG. 5, the method 400 may also include collecting performance data related to the one or more household appliances of the plurality of household appliances during or after step 410 (or 310) of performing the cycle according to the test value of the one or more cycle parameters. For example, in some embodiments, the performance data may include one or both of sensor data collected during the cycle and/or user feedback data collected after performing the cycle. In the example embodiment illustrated in FIG. 4, the method 300 includes a step 320 of collecting sensor data from one or more internal sensors in each of the one or more household appliances of the plurality of household appliances to which the test value was applied while the one or more household appliances of the plurality of household appliances to which the test value was applied perform a cycle according to the test value of the one or more cycle parameters and a step 330 of collecting user feedback data from users of the one or more household appliances of the plurality of household appliances to which the test value was applied after the one or more household appliances of the plurality of household appliances to which the test value was applied perform the cycle according to the test value of the one or more cycle parameters.

Example performance data, e.g., user feedback data, which may be collected after the cycle include consumer wash satisfaction, consumer dry satisfaction, consumer noise satisfaction, and/or consumer cycle time satisfaction, among other possible example user feedback data. The user feedback data may be collected via a remote user interface device (e.g., computer, smartphone, etc., as discussed above).

Although sensors are not specifically illustrated, those of ordinary skill in the art will recognize that the household appliance may include one or more sensors such as, for example in embodiments where the household appliance is a dishwasher appliance, water level sensors, pressure sensors, temperature sensors, turbidity sensors, and/or flowmeters, among other sensors (such example sensors may also apply to other household appliances, such as temperature sensors may also be provided in a refrigerator appliance, oven appliance, laundry appliance, etc., and turbidity sensors, and/or flowmeters may be provided, e.g., in a washing machine appliance). The structure and function of such sensors are understood by those of ordinary skill in the art and, as such, the sensors are not illustrated or discussed in further detail herein for the sake of brevity and clarity. Example performance data, e.g., sensor data, which may be collected during the cycle include, for dishwasher appliances, wash fluid temperature, wash fluid turbidity, internal sump pressure, wash fluid conductivity, circulation discharge pressure, spray arm RPM, latch status, and/or fault codes, among other possible example sensor data.

As illustrated at 340 in FIG. 4 and at 430 in FIG. 5, the method 300 or 400 may also include developing an optimized value for each of the one or more cycle parameters based on the performance data, e.g., based on the sensor data and/or user feedback data. In one example, e.g., for a dishwasher appliance, the test values may include a test value for the target temperature for circulation and a test value for dry fan on/off time, and the performance data may include consumer feedback data such as consumer dry satisfaction and consumer cycle time satisfaction. In such examples, the optimized values may include a higher target temperature for circulation and/or a longer on time for the dry fan when the user feedback data represents lower satisfaction with dry performance than with cycle time, or the optimized values may include a shorter on time for the dry fan when the user feedback data represents higher satisfaction with dry performance and lower satisfaction with cycle time.

As illustrated at 350 in FIG. 4 and at 440 in FIG. 5, the method 300 or 400 may then include applying the optimized value for each of the one or more cycle parameters. In some embodiments, the optimized value or values may only be applied to those household appliances which were part of the test group, e.g., only those household appliances for which the test values were received and applied. In other embodiments, additional household appliances may also be connected to the data server and such additional units may receive and apply the optimized values as well. For example, referring back to FIG. 3, a plurality 210 of household appliances 100 may be connected to the data server 200, and a first plurality 212 of household appliances 100 may receive and apply the test values, while a second plurality 214 of household appliances 100 does not receive or apply the test values. In such examples, the optimized values may be distributed to and applied by only the first plurality 212 of household appliances 100, or, in other embodiments, the optimized values may be distributed to and applied by all of the units connected to the data server, e.g., to the entire plurality 210 of household appliances 100.

In some embodiments, applying the test value of the one or more cycle parameters may include overriding an initial value of the or each cycle parameter(s). For example, the household appliances 100 may be sold with initial or default values for the cycle parameters preprogrammed into the memory of each unit. Such initial values may be developed prior to or around the time of manufacture of the household appliances 100 and may be programmed into each household appliance 100 at the factory or otherwise prior to an initial retail sale of the household appliance 100.

As mentioned above with respect to FIG. 3, the plurality 210 of household appliances 100 connected to the data server 200 may include opted-in units, e.g., first plurality 212, and non-opted units, e.g., second plurality 214. In some embodiments, the method may further include a prompt to opt in on a user interface associated with each household appliance 100 of the plurality 210 of household appliances 100 prior to applying the test value(s). As discussed above, the user interface associated with each household appliance 100 may be on the household appliance 100, such as the user interface panel 136, or may be provided on a remote user interface device. The remote user interface device may be associated with the household appliance 100 in that the remote user interface device is registered with or connected to a user account, e.g., on the data server, that the household appliance 100 is also registered with or connected to, and/or the remote user interface device may be associated with the household appliance 100 in that the remote user interface device is registered to or linked with the household appliance 100, e.g., in the user account or in the household appliance 100 itself. In such embodiments, the method of operating the plurality of household appliances 100 may then include receiving an affirmative response to the prompt to opt in from the user interface associated with one or more household appliances 100 of the plurality 210 of household appliances 100, such as from the first plurality 212 of household appliances 100. In such embodiments, the step of applying the test value may include applying the test value to one or more cycle parameters of the one or more household appliances of the plurality of household appliances where the affirmative response was received from the associated user interface, e.g., the test value may be distributed to and applied by only the opted-in units that are connected to the data server.

As discussed above, the household appliances 100 which receive and implement the test values may be less than all of the household appliances 100, such as only opted-in units. In additional embodiments, one or more additional, specific, criteria may also or instead be applied to select which household appliances 100 are tested. For example, only a certain model of household appliances may be tested for a certain cycle parameter and/or only household appliances having a certain feature set may be tested for the particular cycle parameter. In such embodiments, the tested household appliances 100 may include only opted-in units that are the selected model and/or have the selected feature set. For example, in embodiments where the household appliances are dishwasher appliances, different dishwasher appliances 100 that are connected to the data server 200 may have different spray features. Some dishwasher appliances include a three-level spray system, e.g., including lower spray arm assembly 144, mid-level spray arm assembly 148, and upper sprayer 150, whereas other dishwasher appliances 100 may include a two-level spray system, e.g., only the lower spray arm assembly 144 and mid-level spray arm assembly 148. In some embodiments, the dishwasher appliances 100 to which the test values are applied may be only those dishwasher appliances 100 that are connected to the data server 200 and have a selected feature set, such as only connected dishwasher appliances 100 with a three-level spray system or only connected dishwasher appliances 100 with a two-level spray system. For example, the dishwasher appliances 100 to which the test values are applied may be only those dishwasher appliances 100 for which an affirmative response to the prompt to opt-in has been received and which possess the selected feature set, e.g., the two-level or three-level spray system. In additional example embodiments, the one or more household appliances of the plurality of household appliances to which the test value is applied may be selected based on one or more of geographical location information associated with each household appliance of the plurality of household appliances, consumer metadata, or historic usage data such as, e.g., in dishwasher appliances, unit cycle count, historic wash fluid temperature data, historic wash fluid turbidity data, historic internal sump pressure, historic wash fluid conductivity, historic circulation discharge pressure, historic spray arm RPM, historic consumer satisfaction (wash/dry/noise/time), historic fault codes, and/or historic latch status, in various combinations as well as or instead of the unit type or feature set.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a plurality of household appliances, the plurality of household appliances connected to a data server, the method comprising:
applying a test value to one or more cycle parameters of one or more household appliances of the plurality of household appliances;
collecting sensor data from one or more internal sensors in each of the one or more household appliances of the plurality of household appliances to which the test value was applied while the one or more household appliances of the plurality of household appliances to which the test value was applied perform a cycle according to the test value of the one or more cycle parameters;
collecting user feedback data from users of the one or more household appliances of the plurality of household appliances to which the test value was applied after the one or more household appliances of the plurality of household appliances to which the test value was applied perform the cycle according to the test value of the one or more cycle parameters;
developing an optimized value for each of the one or more cycle parameters based on the sensor data and the user feedback data; and
applying the optimized value for each of the one or more cycle parameters to the one or more household appliances of the plurality of household appliances to which the test value was applied.

2. The method of claim 1, wherein applying the test value comprises overriding an initial value of the one or more cycle parameters.

3. The method of claim 2, wherein each household appliance of the plurality of household appliances comprises a memory, and wherein the initial value of the one or more cycle parameters is programmed into the memory of each household appliance of the plurality of household appliances prior to an initial retail sale of the household appliance.

4. The method of claim 1, wherein the plurality of household appliances comprises opted-in units and non-opted units, and wherein the one or more household appliances of the plurality of household appliances to which the test value was applied consists of the opted-in units.

5. The method of claim 4, wherein applying the optimized value comprises applying the optimized value for each of the one or more cycle parameters to each household appliance of the plurality of household appliances.

6. The method of claim 1, further comprising providing a prompt to opt in on a user interface associated with each household appliance of the plurality of household appliances prior to the step of applying the test value, receiving an affirmative response to the prompt to opt in from the user interface associated with one or more household appliances of the plurality of household appliances, and wherein the step of applying the test value comprises applying the test value to one or more cycle parameters of the one or more household appliances of the plurality of household appliances where the affirmative response was received from the associated user interface.

7. The method of claim 1, wherein the one or more household appliances of the plurality of household appliances to which the test value is applied consists of household appliances of a selected model.

8. The method of claim 1, wherein the one or more household appliances of the plurality of household appliances to which the test value is applied are selected based on geographical location information associated with each household appliance of the plurality of household appliances.

9. The method of claim 1, wherein the one or more household appliances of the plurality of household appliances to which the test value is applied are selected based on historic user feedback data collected prior to the step of applying the test value.

10. The method of claim 1, wherein the one or more household appliances of the plurality of household appliances to which the test value is applied are selected based on historic usage data for each household appliance of the plurality of household appliances collected prior to the step of applying the test value.

11. A method of operating a plurality of household appliances, the plurality of household appliances connected to a data server, the method comprising:
applying a test value to one or more cycle parameters of the plurality of household appliances;
performing a cycle according to the test value of the one or more cycle parameters with one or more household appliances of the plurality of household appliances;
collecting performance data related to the one or more household appliances of the plurality of household appliances during or after performing the cycle according to the test value of the one or more cycle parameters;
developing an optimized value for each of the one or more cycle parameters based on the performance data; and
applying the optimized value for each of the one or more cycle parameters to the plurality of household appliances.

12. The method of claim 11, wherein the plurality of household appliances comprises a plurality of opted-in units, and a plurality of non-opted units are also connected to the data server, further comprising applying the optimized value to each of the one or more cycle parameters of the plurality of non-opted units.

13. The method of claim 11, wherein applying the test value comprises overriding an initial value of the one or more cycle parameters.

14. The method of claim 13, wherein each household appliance of the plurality of household appliances comprises a memory, and wherein the initial value of the one or more cycle parameters is programmed into the memory of each household appliance of the plurality of household appliances prior to an initial retail sale of the household appliance.

15. The method of claim 11, wherein the plurality of household appliances consists of household appliances of a selected model.

16. The method of claim 11, wherein the plurality of household appliances are selected based on geographical location information.

17. The method of claim 11, wherein the plurality of household appliances are selected based on user feedback data collected prior to the step of applying the test value.

18. The method of claim 11, wherein the plurality of household appliances are selected based on historic usage data collected prior to the step of applying the test value.

19. The method of claim 11, wherein the performance data is sensor data collected during performing the cycle according to the test value of the one or more cycle parameters.

20. The method of claim 11, wherein the performance data is user feedback data collected after performing the cycle according to the test value of the one or more cycle parameters.
